(19) United States
(12) Patent Application Publication
(10) Pub. No.: US 2023/0256660 A1
(43) Pub. Date: Aug. 17, 2023

(54) NET-SHAPE COMPOSITES AND METHODS OF PREPARATION THEREOF

(71) Applicants: Hamed LAKROUT, San Antonio, TX (US); WESTLAKE ROYAL BUILDING PRODUCTS INC., Houston, TX (US)

(72) Inventor: Hamed LAKROUT, San Antonio, TX (US)

(73) Assignee: WESTLAKE ROYAL BUILDING PRODUCTS INC., Houston, TX (US)

(21) Appl. No.: 18/003,193

(22) PCT Filed: Jun. 17, 2021
(86) PCT No.: PCT/US2021/037769

§ 371 Date: Dec. 23, 2022

Related U.S. Application Data
(60) Provisional application No. 63/043,808, filed on Jun. 25, 2020.

(51) Int. Cl. B29C 48/12; B29C 48/13

(52) U.S. Cl. CPC B29C 48/12; B29C 48/13; B29L 2028/00

(57) ABSTRACT

Net-shape composites and methods of manufacturing are described herein. The method of preparing net-shape composites may include combining a first semi-solid component with a second semi-solid component to form a polymer composition, and forming the polymer composition into the net-shape composite, wherein each of the semi-solid components has a yield stress of at least 50 Pa. The first semi-solid component may include a first portion of a filler, and the second semi-solid component may include a second portion of a filler that is the same or different than the filler of the first semi-solid component.

### CROSS-REFERENCE TO RELATED APPLICATION

This application claims priority to U.S. Provisional Application No. 63/043,808, filed on Jun. 25, 2020, which is incorporated herein by reference in its entirety.

### TECHNICAL FIELD

The present disclosure generally relates to net-shape composites, and methods of preparation thereof.

### BACKGROUND

Polymer composites are useful for various applications due to their physicochemical properties. Manufacturing such composites may present challenges. To prepare such polymer composites, reactants and fillers are typically combined with limited time during which the reaction mixture can be sufficiently manipulated before the composite is cured and/or set to a point where changing its shape requires further processing, manipulation, or some other dimensional or shape change to occur. Additionally, many manufacturing processes provide insufficient mixing or distribution of the reactants within the composite or amongst each other, leading to products with inadequate or inconsistent strength and durability.

### SUMMARY

The present disclosure includes net-shape composites and related methods of preparation and use thereof. For example, the present disclosure includes a method of preparing a net-shape composite, the method comprising combining a first semi-solid component with a second semi-solid component to form a polymer composition, wherein the first semi-solid component comprises a first portion of a filler, and the second semi-solid component comprises a second portion of a filler that is the same or different from the filler of the first semi-solid component; and forming the polymer composition into a net-shape composite; wherein each of the first semi-solid component and second semi-solid component has a yield stress of at least 50 Pa. For example, the yield stress of the first semi-solid component and/or the second semi-solid component may be 2000 Pa to 5000 Pa.

According to some examples herein, a total amount of filler present in the net-shape composite may be greater than or equal to 50% by weight, such as, e.g., 70% to 99% by weight, based on the total weight of the net-shape composite. Additionally or alternatively, the first semi-solid component and/or the second semi-solid component may comprise at least 20% filler by weight, with respect to the total weight of the respective first semi-solid component or second semi-solid component. The filler of the first semi-solid component and/or the second semi-solid component optionally may comprise fly ash, bottom ash, glass microspheres, cenospheres, perlite, expanded perlite, calcium carbonate, or a combination thereof.

In at least one example, the first semi-solid component comprises a polyol, and the second semi-solid component comprises an isocyanate. The first semi-solid component and/or the second semi-solid component may further comprise water, a surfactant, a fire retardant, a pigment, a UV stabilizer, a fiber material, or a combination thereof.

According to some examples herein, forming the polymer composition into the net-shape composite may comprise extrusion, co-extrusion, injection molding, rolling, or embossing. For example, forming the polymer composition into the net-shape composite may include passing the polymer composition through at least one die. The net-shape composite may include a plurality of surface features, such as, e.g., an aperture and/or a plurality of grooves.

The present disclosure also includes a method of preparing a net-shape composite, the method comprising preparing a first semi-solid component comprising a polyol and a first portion of a filler, the first semi-solid component having a yield stress of at least 50 Pa; preparing a second semi-solid component comprising an isocyanate and a second portion of a filler that is the same or different than the filler of the first semi-solid component, the second semi-solid component having a yield stress of at least 50 Pa; combining the first semi-solid component with the second semi-solid component to form a polymer composition; and forming the polymer composition into the net-shape composite, for example, by extrusion, co-extrusion, or injection molding. In some examples, the polymer composition may be a first polymer composition, and forming the polymer composition into the net-shape composite may include co-extruding the first polymer composition with a second polymer composition. The second polymer composition may have a chemical composition different from that of the first polymer composition.

The present disclosure also includes a net-shape composite comprising a thermosetting polymer and a filler present in an amount of greater than or equal to 70% by weight, based on the total weight of the net-shape composite. The net-shape composite may be a single, integral piece, optionally devoid of foam. The net-shape composite may include a plurality of surface features, wherein the net-shape composite is formed by extrusion, co-extrusion, or injection molding. The plurality of surface features may include, for example, a plurality of grooves. According to some aspects, the filler may be present in an amount of 20% to 80% by weight, based on the total weight of the net-shape composite. The net-shape composite optionally may further comprise a fiber material. Additionally or alternatively, the filler may comprise fly ash, bottom ash, glass microspheres, cenospheres, perlite, expanded perlite, calcium carbonate, or a combination thereof. An exemplary method of preparing the net-shape composite includes combining a first semi-solid component with a second semi-solid component to form a polymer composition, wherein the first semi-solid component comprises a first portion of a filler, and the second semi-solid component comprises a second portion of the filler, each of the first semi-solid component and the second semi-solid component having a yield stress of at least 50 Pa; and forming the polymer composition into the net-shape composite by extrusion, co-extrusion, or injection molding. In at least some examples herein, the net-shape composite includes a plurality of layers, e.g., prepared by co-extrusion.

### DETAILED DESCRIPTION

The singular forms “a,” “an,” and “the” include plural reference unless the context dictates otherwise. The terms “approximately” and “about” refer to being nearly the same as a referenced number or value. As used herein, the terms “approximately” and “about” generally should be understood to encompass ±5% of a specified amount or value. All ranges are understood to include endpoints, e.g., a molecular weight between 250 g/mol and 1000 g/mol includes 250 g/mol, 1000 g/mol, and all values between.

The present disclosure generally includes net-shape composites and methods of preparing such net-shape composites. The net-shape composites herein may be prepared by combining two or more separate components, such as two or more semi-solid components. As used herein, the term “semi-solid” refers to a moldable material capable of supporting its own weight and holding its shape over at least a period of time, but yet conforms in shape or flows upon application of pressure, such as a putty or paste. For example, the semi-solid components may have a yield stress of 50 Pa to 5000 Pa, such as 100 Pa to 300 Pa, 250 Pa to 2000 Pa, 500 Pa to 1000 Pa, 1000 Pa to 2000 Pa, 2500 Pa to 4000 Pa, 3000 Pa to 5000 Pa, 3500 Pa to 4500 Pa, or 1000 Pa to 3000 Pa. Yield stress may be considered to be a measure of pourability and spreadability. Exemplary yield stress values for reference purposes include about 20-300 Pa for mayonnaise (ranging from a pourable to spoonable consistency), ˜110 Pa for skin cream, ˜135 for hair gel, 500 Pa for chocolate spread, and ˜1800 Pa for peanut butter. Yield stress may be measured according to ASTM C1749-12 Standard Guide for Measurement of the Rheological Properties of Hydraulic Cementious Paste Using a Rotational Rheometer.

Each semi-solid component may include one or more fillers, fibers, and/or other materials. The semi-solid components may have relatively high shear strength and/or relatively high shear forces during mixing of the components and/or subsequent forming (e.g., extruding), which allows for a better dispersion of the filler and/or fiber materials throughout the polymer composition and net-shape composite.

The properties of the semi-solid components may allow the components to be formed into a final net-shape, as discussed below. As used herein, the term “net-shape” refers to a piece produced with a finalized or near-final configuration, e.g., a polymeric composite having a desired shape without further processing, manipulation, dimensional change, or size change after the forming of the polymer composition into a composite. Net-shape composites as discussed herein may be prepared by combining two or more semi-solid components, and forming the resulting mixture into the desired shape in a process, such as a molding or extrusion process, without additional shaping or combining multiple pieces together. For example, two semi-solid components may be mixed to form a polymer composition that is then extruded through a die to form a net-shape composite with a desired shape and configuration following the extrusion process. Once the net-shape composite is cured and/or set (e.g., once the composite solidifies), it may be used in any appropriate manner.

According to some aspects of the present disclosure, the net-shape composites may be prepared by combining a first semi-solid component with a second semi-solid component to form a polymer composition. For example, each semi-solid component may comprise reactants that, when mixed together, form a polymer. Such reactants may include, but are not limited to, organic compounds with various functional groups, e.g., hydroxyl groups (including polyols and other alcohols), isocyanates, amines, ketones, carbonyl groups, and thiol groups, among other types of functional groups, and combinations thereof. Each semi-solid component may include one or more additional materials, such as fillers (e.g., inorganic particles), fibers, surfactants, blowing agents, chain-extenders, crosslinkers, coupling agents, UV stabilizers, fire retardants, antimicrobials, anti-oxidants, and/or pigments. Exemplary chemical compositions of semi-solid components are further discussed below.

In at least one example, each of the first semi-solid component and second semi-solid component comprises a filler and a liquid. For example, the filler may comprise inorganic particles and the liquid may comprise one or more organic compounds. The fillers and liquids of the respective first and second semi-solid components may be the same or different. For example, the first and second semi-solid components may comprise the same type of filler but different types of organic compounds or mixtures of organic components.

The semi-solid components may be prepared separately using any appropriate technique. For example, each semi-solid component may be prepared with a mixing tool, for example, a stand mixer or paddle mixer, wherein the filler(s) and the organic compound(s) are sufficiently mixed to produce a semi-solid consistency (e.g., similar to a putty or paste). Each of the semi-solid components may be sufficiently mixed so as to form a homogenous mixture, such that the filler or fillers are evenly dispersed (e.g., no dry spots are present). The semi-solid components may be combined shortly after (e.g., within 20-30 minutes) or immediately after each semi-solid component is prepared (e.g., as part of a continuous process).

The first and second semi-solid components then may be combined using any appropriate technique, e.g., combining the components with a mixing tool, such as a paddle mixer, screw extruder (e.g., co-extrusion), or industrial mixer/kneader. The first and second semi-solid components may be sufficiently mixed to allow for formation of a polymer, e.g., a substantially homogeneous polymer composition. For example, the semi-solid components may be mixed for a period of time of about 10 seconds to about 1 minute, e.g., 15 seconds to 45 seconds, or 20 seconds to 30 seconds. Once the semi-solid components are combined, the yield stress of the resulting mixture may change, e.g., as the polymer forms and the polymer composition begins to cure and/or set (e.g., solidify).

Before the polymer composition is cured and/or set, the polymer composition may be formed into a desired shape or configuration, producing a net-shape composite. As discussed above, it may be difficult to mold and shape polymer compositions that are fluid-like and/or have low viscosity, or polymer compositions that cure too quickly. With respect to fluid-like polymer compositions, for example, the viscosity of the mixture may limit the ability to shape the compositions without a container or mold. It may also be more difficult to evenly distribute filler and/or fiber materials in a fluid or fluid-like polymer composition. Similarly, a mixture that cures too quickly may not allow enough time to produce the desired shape. The methods herein may provide for semi-solid components with higher shear strength, which in turn, may lead to more evenly filled polymer compositions, e.g., having a homogeneous distribution of filler and other materials in the polymer matrix. A more homogeneous chemical composition may provide improved mechanical properties, such as compressive strength, flexural strength, and/or modulus of elasticity.

Once the semi-solid components are combined to form the polymer composition, any suitable process or technique may be used to shape the polymer composite into the desired configuration to produce a net-shape composite. Such processes and techniques may include, but are not limited to, extrusion, co-extrusion, injection molding, rolling, and embossing. Net-shape composites according to the present disclosure may be devoid of foam.

In some examples, forming the polymer composition into the net-shape composite may include passing the polymer composition through an extrusion die. For example, the die may have a fixed cross-sectional shape corresponding to the cross-sectional shape desired for the net-shape composite. For example, the extrusion die may have a shape defining one or more cavities such that the polymer composition assumes the shape of the cavity or cavities when passed through the die and exits the die as a net-shape composite with the desired shape.

In other examples, the net-shape composites may be prepared by co-extrusion. For example, a first polymer composition may be co-extruded with a second polymer composition to form a net-shape composite, the first and second polymer compositions being physically adjacent in the net-shape composition and not completely (e.g., homogeneously) mixed together. That is, the polymer compositions may retain their individual chemical compositions, e.g., the polymer compositions being at least partially distinguishable from one another in the net-shape composite. For example, a first polymer composition may be co-extruded with a second polymer composition to form two or more layers that together define the net-shape composite. The polymer compositions may be combined via co-extrusion during a workability time, while they are still malleable, so as to be shaped together to form the net-shape composite. As mentioned above, the net-shape composite may be devoid of foam.

The net-shape composites herein may be prepared with any desired dimensions or shapes. For example, all or part of the net-shape composite may have a circular shape and/or cross-section, a polygonal shape and/or cross-section such as triangular, rectangular, pentagonal, hexagonal, etc., or any other suitable configuration, including a cross-shape, crescent (half-moon) shape and/or cross-section. In some examples, the net-shape composite may have a tubular structure, or cylindrical structure, e.g., a circular cross-section along at least a portion of its length.

In some examples, the net-shape composite may have a generally rectangular shape, such as a flat sheet or a panel, optionally with one or more grooves, bends, angles, or notches. For example, the net-shape composite may have a length (measured along the x-axis) of greater than or equal to 2 feet, a width (measured along the y-axis) of greater than or equal to 2 feet, and a thickness (measured along the z-axis) of greater than or equal to 0.01 inch For example, the net-shape composite may have a length of 2 feet to 30 feet (such as, e.g., 5 feet to 10 feet, 15 feet to 25 feet, or 20 feet to 30 feet), a width of 2 feet to 10 feet (such as, e.g., 2 feet to 5 feet, 4 feet to 8 feet, or 6 feet to 10 feet), and a thickness of 0.01 inch to 12 inches (such as, e.g., 0.05 inches to 0.5 inches, 0.1 inches to 1 inch, 0.5 inches to 3 inches, 1 inch to 5 inches, 2 inches to 8 inches, 5 inches to 10 inches, or 9 inches to 12 inches). These dimensions are exemplary only. In some examples, the net-shape composite may define at least one opening, aperture, cavity, curvature, or groove. For example, when a die or combination of dies are used to prepare the net-shape composite, a solid part of the die(s) may produce an aperture in the resulting net-shape composite.

As mentioned above, preparing a polymer composite from two or more semi-solid components according to the methods herein may facilitate manufacturing and/or provide benefits in the resulting composite. Further, as indicated above, each semi-solid component may comprise reactants that, when mixed together, form a polymer. Such reactants may include, but are not limited to, organic compounds with various functional groups, e.g., hydroxyl groups (including polyols and other alcohols), isocyanates, amines, ketones, carbonyl groups, and thiol groups, among other types of functional groups, and combinations thereof.

The polymer of the net-shape composites herein may comprise a thermosetting polymer. For example, the polymer may comprise an epoxy resin, phenolic resin, bismaleimide, polyimide, polyolefin, polyurethane, polystyrene, or a combination thereof. Thus, to prepare a polyurethane composite, a first semi-solid component may comprise one or more polyols, and a second semi-solid component may comprise one or more isocyanates, such that polyol(s) and isocyanate(s) react once the components are mixed together.

Isocyanates suitable for use in preparing the net-shape composites herein may include at least one monomeric or oligomeric poly- or di-isocyanate. Exemplary diisocyanates include, but are not limited to, methylene diphenyl diisocyanate (MDI), including MDI monomers, oligomers, and combinations thereof. The particular isocyanate used in a semi-solid component may be selected based on the desired yield stress to produce the net-shape composite. Other factors that may influence the particular isocyanate can include the reactivity of the semi-solid component (to produce the polymer composition) and/or overall properties of the net-shape composite, such as the strength of bonding to a filler, wetting of filler(s) in the semi-solid components, and/or mechanical properties of the resulting net-shape composite, such as compressive strength, flexural strength, and stiffness (elastic modulus).

Polyols useful for the semi-solid components, polymer compositions, and net-shape composites herein may be in liquid form. For example, liquid polyols having relatively low viscosities generally facilitate mixing. Suitable polyols include those having viscosities of 6000 cP or less at 25° C., such as a viscosity of 150 cP to 5000 cP, 250 cP to 4500 cP, 500 cP to 4000 cP, 750 cP to 3500 cP, 1000 cP to 3000 cP, or 1500 cP to 2500 cP at 25° C. Further, for example, the polyol(s) may have a viscosity of 5000 cP or less, 4000 cP or less, 3000 cP or less, 2000 cP or less, 1000 cP or less, or 500 cP or less at 25° C.

The polyols useful for the semi-solid components, polymer compositions, and net-shape composites herein may include compounds of different reactivity, e.g., having different numbers of primary and/or secondary hydroxyl groups. In some embodiments, one or more polyols may be capped with an alkylene oxide group, such as ethylene oxide, propylene oxide, butylene oxide, and combinations thereof, to provide the polyols with the desired reactivity. In some examples, the polyols can include a poly(propylene oxide) polyol including terminal secondary hydroxyl groups, the compounds being end-capped with ethylene oxide to provide primary hydroxyl groups.

The polyol(s) useful for the present disclosure may have a desired functionality. For example, the functionality of the polyol(s) may be 7.0 or less, e.g., 1.0 to 7.0, or 2.5 to 5.5. In some examples, the functionality of the polyol(s) may be 6.5 or less, 6.0 or less, 5.5 or less, 5.0 or less, 4.5 or less, 4.0 or less, 3.5 or less, 3.0 or less, 2.5 or less, and/or 1.0 or greater, 2.0 or greater, 2.5 or greater, 3.0 or greater, 3.5 or greater, or 4.0 or greater, or 4.5 or greater, or 5.0 or greater. The average functionality of the polyols useful for the semi-solid components herein may be 1.5 to 5.5, 2.5 to 5.5, 3.0 to 5.5, 3.0 to 5.0, 2.0 to 3.0, 3.0 to 4.5, 2.5 to 4.0, 2.5 to 3.5, or 3.0 to 4.0.

The polyol(s) useful for the semi-solid components, polymer compositions, and net-shape composites herein may have an average molecular weight of 250 g/mol or greater and/or 1500 g/mol or less. For example, the polyol(s) may have an average molecular weight of 300 g/mol or greater, 400 g/mol or greater, 500 g/mol or greater, 600 g/mol or greater, 700 g/mol or greater, 800 g/mol or greater, 900 g/mol or greater, 1000 g/mol or greater, 1100 g/mol or greater, 1200 g/mol or greater, 1300 g/mol or greater, or 1400 g/mol or greater, and/or 1500 g/mol or less, 1400 g/mol or less, 1300 g/mol or less, 1200 g/mol or less, 1100 g/mol or less, 1000 g/mol or less, 900 g/mol or less, 800 g/mol or less, 700 g/mol or less, 600 g/mol or less, 500 g/mol or less, 400 g/mol or less, or 300 g/mol or less. In some cases, the one or more polyols have an average molecular weight of 250 g/mol to 1000 g/mol, 500 g/mol to 1000 g/mol, or 750 g/mol to 1250 g/mol.

Polyols useful for the semi-solid components, polymer compositions, and net-shape composites herein include, but are not limited to, aromatic polyols, polyester polyols, poly ether polyols, Mannich polyols, and combinations thereof. Exemplary aromatic polyols include, for example, aromatic polyester polyols, aromatic polyether polyols, and combinations thereof. Exemplary polyester and poly ether polyols useful in the present disclosure include, but are not limited to, glycerin-based polyols and derivatives thereof, polypropylene-based polyols and derivatives thereof, and poly ether polyols such as ethylene oxide, propylene oxide, butylene oxide, and combinations thereof that are initiated by a sucrose and/or amine group. Mannich polyols are the condensation product of a substituted or unsubstituted phenol, an alkanolamine, and formaldehyde. Examples of Mannich polyols that may be used include, but are not limited to, ethylene and propylene oxide-capped Mannich polyols.

The semi-solid components used to prepare the polymer compositions and net-shape composites optionally may comprise one or more additional isocyanate-reactive monomers, e.g., in addition to one or more polyols. The additional isocyanate-reactive monomer(s) can be present in an amount of 30% or less, 25% or less, 20% or less, 15% or less, 10% or less, or 5% or less by weight, based on the weight of the one or more polyols. Exemplary isocyanate-reactive monomers include, for example, polyamines corresponding to the polyols described herein (e.g., a polyester polyol or a polyether polyol), wherein the terminal hydroxyl groups are converted to amino groups, for example by amination or by reacting the hydroxyl groups with a diisocyanate and subsequently hydrolyzing the terminal isocyanate group to an amino group. For example, the semi-solid component may comprise a poly ether polyamine, such as polyoxyalkylene diamine or polyoxyalkylene triamine.

In some embodiments, the semi-solid component may comprise an alkoxylated polyamine (e.g., alkylene oxide-capped polyamines) derived from a polyamine and an alkylene oxide. Alkoxylated polyamines may be formed by reacting a suitable polyamine (e.g., monomeric, oligomeric, or polymeric polyamines) with a desired amount of an alkylene oxide. The polyamine may have a molecular weight less than 1000 g/mol, such as less than 800 g/mol, less than 750 g/mol, less than 500 g/mol, less than 250 g/mol, or less than 200 g/mol. In some embodiments, the ratio of number of isocyanate groups to the total number of isocyanate reactive groups (e.g., hydroxyl groups, amine groups, and water) in the semi-solid component is 0.5:1 to 1.5:1, which when multiplied by 100 produces an isocyanate index of 50 to 150. In some embodiments, the semi-solid component may have an isocyanate index equal to or less than 140, equal to or less than 130, or equal to or less than 120. For example, with respect to a semi-solid component used to prepare some polymer compositions herein, the isocyanate index may be 80 to 140, 90 to 130, or 100 to 120. Further, for example, with respect to polyisocyanurate composites, the isocyanate index may be 180 to 380, such as 180 to 350 or 200 to 350.

When the two or more semi-solid components are combined (e.g., a first semi-solid component comprising an isocyanate, and a second semi-solid component comprising one or more polyolys), the isocyanate and the polyol(s) may be present in the resulting polymer composition and net-shape composite in a weight ratio (isocyanate:polyol) less than 1:2. For example, the weight ratio may be about 1:3, about 1:4, about 1:5, or about 1:6, e.g., a weight ratio of 1:6 to 1:2.

The polymer compositions and net-shape composites herein may be prepared with a catalyst, e.g., to facilitate curing and control curing times when the semi-solid components are combined. Thus, for example, one or more of the semi-solid components to be combined may comprise at least one catalyst. Examples of suitable catalysts include, but are not limited to catalysts that comprise amine groups (including, e.g., tertiary amines such as 1,4-diazabicyclo[2.2.2]octane (DABCO), tetramethylbutanediamine, and diethanolamine) and catalysts that contain tin, mercury, or bismuth. The amount of catalyst in each semi-solid component may be selected, such that the total amount of catalyst in the polymer composition is 0.01% to 10% based on the total weight of the polymer composition. For example, the amount of catalyst in the polymer composition may be 0.05% to 0.5% by weight, or 0.1% to 0.25% by weight, based on the total weight of the polymer composition.

The semi-solid components may comprise one or more fillers, e.g., to achieve the semi-solid consistency, facilitate mixing, and provide suitable reaction times when forming the polymer composition and resulting net-shape composite. The filler may comprise an inorganic material or combination of materials, e.g., the filler comprising inorganic particles. In some examples, the filler may comprise calcium, silicon, aluminum, magnesium, carbon, or a mixture thereof. Exemplary fillers useful for the shapeable composites herein include, but are not limited to, fly ash, bottom ash, amorphous carbon (e.g., carbon black), silica (e.g., silica sand, silica fume, quartz), glass (e.g., ground/recycled glass such as window or bottle glass, milled glass, glass spheres and microspheres, glass flakes), calcium, calcium carbonate, calcium oxide, calcium hydroxide, aluminum, aluminum trihydrate, clay (e.g., kaolin, red mud clay, bentonite), mica, talc, wollastonite, alumina, feldspar, gypsum (calcium sulfate dehydrate), garnet, saponite, beidellite, granite, slag, antimony trioxide, barium sulfate, magnesium, magnesium oxide, magnesium hydroxide, aluminum hydroxide, gibbsite, titanium dioxide, zinc carbonate, zinc oxide, molecular sieves, perlite (including expanded perlite), diatomite, vermiculite, pyrophillite, expanded shale, volcanic tuff, pumice, hollow ceramic spheres, cenospheres, and mixtures thereof. The semi-solid components combined according to the methods herein may comprise the same type and/or amounts of filler or different types and/or amounts of filler.

In some embodiments, the filler of at least one semi-solid component may comprise an ash produced by firing fuels including coal, industrial gases, petroleum coke, petroleum products, municipal solid waste, paper sludge, wood, sawdust, refuse derived fuels, switchgrass, or other biomass material. For example, the filler may comprise a coal ash, such as fly ash, bottom ash, or combinations thereof. Fly ash is generally produced from the combustion of pulverized coal in electrical power generating plants. In some examples herein, the net-shape composite comprises fly ash selected from Class C fly ash, Class F fly ash, or a mixture thereof. In some embodiments, the filler of the net-shape composite may consist of or consist essentially of fly ash.

The filler(s) may be present in each semi-solid component in an amount of greater than or equal to 20% by weight, based on the total weight of the respective semi-solid component, such as, e.g., 20% to 95% by weight, 30% to 95% by weight, 40% to 95% by weight, 50% to 95% by weight, 60% to 95% by weight, or 70% to 95% by weight. In some examples, the amount of filler(s) in each semi-solid component may be greater than or equal to 20% by weight, greater than or equal to 25% by weight, greater than or equal to 30% by weight, greater than or equal to 35% by weight, greater than or equal to 40% by weight, greater than or equal to 45% by weight, greater than or equal to 50% by weight, greater than or equal to 55% by weight, greater than or equal to 60% by weight, greater than or equal to 65% by weight, greater than or equal to 70% by weight, greater than or equal to 75% by weight, greater than or equal to 80% by weight, greater than or equal to 85% by weight, greater than or equal to 90% by weight, or greater than or equal to 95% by weight. For example, a first semi-solid component and/or second semi-solid component may comprise 75% to 99% by weight filler, e.g., about 75%, about 80%, about 85%, about 90%, or about 95%, by weight filler, based on the total weight of the respective first or second semi-solid component.

The amount of the filler present in the first semi-solid component and the second semi-solid component may be altered depending on the desired yield stress of the semi-solid components to form the polymer composition. As mentioned above, the semi-solid components may comprise fibers and/or additives such as surfactants, blowing agents, chain-extenders, crosslinkers, coupling agents, UV stabilizers, fire retardants, antimicrobials, anti-oxidants, and/or pigments, which may also affect the yield stress of the semi-solid component. The amount of filler by weight present in the first semi-solid component and the second semi-solid component may also be selected depending on the type of filler used (e.g., based on the density, volume, particle size, and/or chemical composition). For example, if a filler having a relatively small particle size is used, higher amounts of the filler may be used to produce the desired yield stress as compared to a filler with a larger particle size. Similarly, the choice of filler may affect the overall density of the net-shape composite. For example, a filler with a relatively large particle size and/or low density (e.g., perlite or expanded perlite) may be selected to produce net-shape composites with lower density as compared to a smaller particle size and/or more dense filler.

The amount of filler in each semi-solid component may be selected such that, when the components are combined, the total amount of filler present in the net-shape composite is greater than or equal to 20% by weight, based on the total weight of the net-shape composite, such as, 20% to 95% by weight, 30% to 95% by weight, 40% to 95% by weight, 50% to 95% by weight, 60% to 95% by weight, or 70% to 95% by weight. The total amount of filler present in the net-shape composite may be greater than or equal to 20% by weight, greater than or equal to 25% by weight, greater than or equal to 30% by weight, greater than or equal to 35% by weight, greater than or equal to 40% by weight, greater than or equal to 45% by weight, greater than or equal to 50% by weight, greater than or equal to 55% by weight, greater than or equal to 60% by weight, greater than or equal to 65% by weight, greater than or equal to 70% by weight, greater than or equal to 75% by weight, greater than or equal to 80% by weight, greater than or equal to 85% by weight, greater than or equal to 90% by weight, or greater than or equal to 95% by weight. For example, the filler in the net-shape composite may be 75% to 99% by weight, e.g., about 75%, about 80%, about 85%, about 90%, or about 95%, by weight, based on the total weight of the net-shape composite.

In some examples, the semi-solid components and net-shape composite may comprise one or more other materials, such as fiber materials. The fiber materials can comprise any natural or synthetic fiber, based on inorganic or organic materials. Exemplary fiber materials include, but are not limited to, glass fibers, silica fibers, carbon fibers, metal fibers, mineral fibers, organic polymer fibers, cellulose fibers, biomass fibers, and combinations thereof. Additionally or alternatively, the semi-solid components and net-shape composites herein may comprise one or more blowing agents (including, e.g., water) foaming agents, surfactants, chain-extenders, crosslinkers, coupling agents, UV stabilizers, fire retardants, antimicrobials, anti-oxidants, cell openers, and/or pigments.

Each semi-solid component may have a yield stress of 50 to 5000 Pa, such as 1000 Pa to 2000 Pa, 1500 Pa to 3000 Pa, 2000 Pa to 5000 Pa, or 3500 Pa to 4500 Pa. Yield stress can be measured as the point on the stress/strain curve that indicates the limit of elastic behavior and the beginning of plastic behavior.

The polymer compositions herein may be capable of maintaining a desired shape, e.g., following extrusion, such that the polymer composition adopts a net shape corresponding to the desired article. For example, the polymer composition may be extruded through a die, wherein the polymer composition exits the die as the net-shape composite.

In some embodiments, the net-shape composites herein have a low or relatively low density. For example, the net-shape composite may have an average density of 2 lb/ft³ (pcf) to 85 pcf, such as 2 pcf to 80 pcf, 2 pcf to 60 pcf, 2 pcf to 40 pcf, 4 pcf to 85 pcf, 2pcf to 10 pcf, or 4 pcf to 10 pcf (1 pcf=16.0 kg/m³). In some examples, the net-shape composite may have an average density greater than or equal to 2 pcf, greater than or equal to 4 pcf, or greater than or equal to 5 pcf, and/or less than or equal to 80 pcf, less than or equal to 70, less than or equal to 60 pcf, less than or equal to 50 pcf, less than or equal to 40 pcf, less than or equal to 30 pcf, less than or equal to 20 pcf, or less than or equal to 10 pcf

The net-shape composites herein may have a compressive strength greater than or equal to 20 psi (145.0 psi=1 MPa), greater than or equal to 40 psi, or greater than or equal to 60 psi, e.g., 20 psi to 500 psi, 30 psi to 400 psi, 40 psi to 450 psi, 50 psi to 100 psi, 300 to 400 psi, 100 to 250 psi, or 60 psi to 90 psi. Compressive strength can be measured by the stress measured at the point of permanent yield, zero slope, or significant change of the stress variation with strain on the stress-strain curve as measured according to ASTM D1621.

Additionally or alternatively, the net-shape composites may have a flexural strength greater than or equal to 5 psi, greater than or equal to 10 psi, greater than or equal to 50 psi, greater than or equal to 100 psi, greater than or equal to 200 psi, greater than or equal to 300 psi, greater than or equal to 400 psi, and/or less than or equal to 500 psi, less than or equal to 400 psi, less than or equal to 300 psi, less than or equal to 200 psi, or less than or equal to 100 psi. Flexural strength can be measured as the load required to fracture a rectangular prism loaded in the three point bend test as described in ASTM C1185-08 (2012), wherein flexural modulus is the slope of the stress/strain curve.

The net-shape composite may have a modulus of elasticity (stiffness) greater than or equal to 10 psi, greater than or equal to 100 psi, greater than or equal to 200 psi, greater than or equal to 300 psi, greater than or equal to 400 psi, greater than or equal to 500 psi, or greater than or equal to 600 psi, greater than or equal to 700 psi, greater than or equal to 800 psi, greater than or equal to 900 psi, or greater than or equal to 1000 psi. The modulus of elasticity can be from 10 psi to 1000 psi, 100 psi to 1000 psi, 200 psi to 1000 psi, 300 psi to 1000 psi, 400 psi to 1000 psi, or 500 psi to 1000 psi. The modulus of elasticity can be determined as described in ASTM C947-03.

The net-shape composites herein may be used for any suitable type of building product or material, such as structural elements and supports. For example, the net-shape composites may be frames or portions thereof (e.g., window frames, window profiles, door frames, etc.), panels, beams, or boards, useful for both interior and exterior areas and structures.

While principles of the present disclosure are described herein with reference to illustrative aspects for particular applications, the disclosure is not limited thereto. Those having ordinary skill in the art and access to the teachings provided herein will recognize additional modifications, applications, aspects, and substitution of equivalents that all fall in the scope of the aspects described herein. Accordingly, the present disclosure is not to be considered as limited by the foregoing description.

### EXAMPLES

The following examples are intended to illustrate the present disclosure without being limiting in nature. It is understood that the present disclosure encompasses additional embodiments consistent with the foregoing description and following examples.

### Example 1

Two different types of polymer composites (Composite 1 and Composite 2) were prepared from polymer compositions (Polymer Composition 1 and Polymer Composition 2, respectively) to test conditions associated with forming net-shape composites according to the present disclosure. The polymer of each polymer composition was polyurethane.

Three semi-solid components were prepared: two comprising a polyol or polyol mixture (Polyol Semi-solid Component A and Polyol Semi-solid Component B, respectively) and a third semi-solid component comprising an isocyanate (Isocyanate Semi-solid Component). The chemical composition of each component is summarized in Table 1. The liquid for Polyol Semi-solid Component A comprised an polyester polyol, and the liquid for Polyol Semi-solid Component B comprised a polyether/polyester/Mannich polyol mixture. The liquid for Isocyanate Semi-solid Component was methylene diphenyl diisocyanate. The filler used for each component was fly ash. Each component was prepared by combining the respective liquids and filler using a stand mixer with a paddle attachment. The resulting semi-solids had a dough-like consistency and could be manually handled without excessively sticking to gloves or containers.

TABLE 1

| Semi-Solid Components | Liquid (g) | Filler (g) | Filler (% wt.) |
|---|---|---|---|
| Polyol Semi-solid Component A | 80 | 400 | 83% |
| Polyol Semi-solid Component B | 80 | 500 | 86% |
| Isocyanate Semi-solid Component | 80 | 400 | 83% |

Polymer Composition 1 was prepared by mixing Polyol Semi-solid Component A and the Isocyanate Semi-solid Component. Polymer Composition 2 was prepared by mixing Polyol Semi-solid Component B and the same Isocyanate Semi-solid Component used to prepare Polymer Composition 1. The components were combined manually in equal amounts, i.e., a weight ratio of 1:1 (polyol semi-solid component:isocyanate semi-solid component).

At the start of combining the semi-solids to form the respective polymer compositions, a timer was started to determine the workability time (as a measure of the time during which a net-shape composite could be formed from each polymer composition), tack free time (as a measure of the time for the net-shape composite to lose its stickiness), and final set time of the respective composites, summarized in Table 2. The workability time refers to the duration of time that the polymer composition could be freely and easily manipulated (e.g., manually, through extrusion, etc.) without clumping or crumbling. That is, the workability time refers to the amount of time each polymer composition (Polymer Composition 1 and Polymer Composition 2) could be shaped before forming the respective net-shape composite (Composite 1 and Composite 2, respectively) having a finalized or near-final configuration. The tack free time refers to the duration of time for the net-shape composite to lose its tackiness or stickiness (e.g., the surface of the net-shape composite is no longer tacky or sticky). The final set time refers to the amount of time for the net-shape composite to be sufficiently cured or set/solidified, such that the surface of the net-shape composite could no longer be dented or deformed.

TABLE 2

| | Composite 1 | Composite 2 |
|---|---|---|
| Workability Time (Min) | 14 | 2.5 |
| Tack Free Time (Min) | 21 | 4 |
| Set Time (Min) | 30 | 7 |

While the results varied in workability time, tack free time, and set time, the mixtures of the filled polyol semi-solids with the filled isocyanate semi-solid formed polymer compositions that could be manipulated for a sufficient duration of time to form a net-shape composite that maintained its final shape. Without intending to be bound by theory, it is believed that the shorter workability time, tack-free time, and set time for Composite 2 is due to higher reactivity of the polyol mixture (polyether/polyester/Mannich polyol mixture) used as compared to the polyol used in Composite 1 (polyester polyol).

It is intended that the specification and examples be considered as exemplary only, with a true scope and spirit of the present disclosure being indicated by the following claims.

What is claimed is:

1. A method of preparing a net-shape composite, the method comprising:
combining a first semi-solid component with a second semi-solid component to form a polymer composition, wherein the first semi-solid component comprises a first portion of a filler, and the second semi-solid component comprises a second portion of a filler that is the same or different from the filler of the first semi-solid component; and
forming the polymer composition into a net-shape composite;
wherein each of the first semi-solid component and second semi-solid component has a yield stress of at least 50 Pa.

2. The method of claim 1, wherein a total amount of filler present in the net-shape composite is greater than or equal to 50% by weight, based on the total weight of the net-shape composite.

3. The method of claim 2, wherein the total amount of filler present in the net-shape composite is 70% to 99% by weight, based on the total weight of the net-shape composite.

4. The method of claim 1, wherein the first semi-solid component and/or the second semi-solid component comprises at least 20% filler by weight, with respect to the total weight of the respective first semi-solid component or second semi-solid component.

5. The method of claim 1, wherein the yield stress of the first semi-solid component and/or the second semi-solid component is 2000 Pa to 5000 Pa.

6. The method of claim 1, wherein the filler of the first semi-solid component and/or the second semi-solid component comprises fly ash, bottom ash, glass microspheres, cenospheres, perlite, expanded perlite, calcium carbonate, or a combination thereof.

7. The method of claim 1, wherein the first semi-solid component comprises a polyol, and the second semi-solid component comprises an isocyanate.

8. The method of claim 1, wherein the first semi-solid component and/or the second semi-solid component further comprises water, a surfactant, a fire retardant, a pigment, a UV stabilizer, a fiber material, or a combination thereof.

9. The method of claim 1, wherein forming the polymer composition into the net-shape composite comprises extrusion, co-extrusion, injection molding, rolling, or embossing.

10. The method of claim 9, wherein forming the polymer composition into the net-shape composite includes passing the polymer composition through at least one die.

11. The method of claim 1, wherein the net-shape composite includes a plurality of surface features, the surface features comprising an aperture and/or a plurality of grooves.

12. A method of preparing a net-shape composite, the method comprising:
preparing a first semi-solid component comprising a polyol and a first portion of a filler, the first semi-solid component having a yield stress of at least 50 Pa;
preparing a second semi-solid component comprising an isocyanate and a second portion of a filler that is the same or different than the filler of the first semi-solid component, the second semi-solid component having a yield stress of at least 50 Pa;
combining the first semi-solid component with the second semi-solid component to form a polymer composition; and
forming the polymer composition into the net-shape composite by extrusion, co-extrusion, or injection molding.

13. The method of claim 12, wherein the polymer composition is a first polymer composition, and forming the polymer composition into the net-shape composite includes co-extruding the first polymer composition with a second polymer composition.

14. A net-shape composite comprising:
a thermosetting polymer; and
a filler present in an amount of greater than or equal to 70% by weight, based on the total weight of the net-shape composite,
wherein the net-shape composite is a single, integral piece devoid of foam; and
wherein the net-shape composite includes a plurality of surface features, the net-shape composite being formed by extrusion, co-extrusion, or injection molding.

15. The net-shape composite of claim 14, wherein the plurality of surface features includes a plurality of grooves.

16. The net-shape composite of claim 14, wherein the filler is present in an amount of 20% to 80% by weight, based on the total weight of the net-shape composite.

17. The net-shape composite of claim 14, wherein the net-shape composite further comprises a fiber material.

18. The net-shape composite of claim 14, wherein the filler comprises fly ash, bottom ash, glass microspheres, cenospheres, perlite, expanded perlite, calcium carbonate, or a combination thereof.

19. The net-shape composite of claim 14, wherein the net-shape composite includes a plurality of layers, the net-shape composite being prepared by co-extrusion.

20. The net-shape composite of claim 14, wherein the net shape composite is prepared by:
combining a first semi-solid component with a second semi-solid component to form a polymer composition, wherein the first semi-solid component comprises a first portion of a filler, and the second semi-solid component comprises a second portion of the filler, each of the first semi-solid component and the second semi-solid component having a yield stress of at least 50 Pa; and
forming the polymer composition into the net-shape composite by extrusion, co-extrusion, or injection molding.
